(19) United States
(12) Patent Application Publication
(10) Pub. No.: US 2025/0172456 A1
(43) Pub. Date: May 29, 2025

(54) TEST STAND SYSTEM FOR TESTING A DRIVER ASSISTANCE SYSTEM USING AN AUDIBLE SOUND SENSOR

(71) Applicant: AVL List GmbH, Graz (AT)

(72) Inventors: Christian GUTENKUNST, Lichtenau (DE); Christian SCHYR, Heidelberg (DE); Max NESTORIUC, Leinfelden (DE)

(21) Appl. No.: 18/841,131

(22) PCT Filed: Feb. 23, 2023
(86) PCT No.: PCT/AT2023/060049

§ 371 Date: Aug. 23, 2024

(30) Foreign Application Priority Data
Feb. 24, 2022 (AT) A 50123/2022

(51) Int. Cl. G01M 17/007; B60R 16/023; B60W 50/04; G06F 3/16; H04R 3/04

(52) U.S. Cl. CPC G01M 17/007; B60R 16/0232; B60W 50/04; G06F 3/162; H04R 3/04; H04R 2410/07; H04R 2499/13

(57) ABSTRACT

The invention relates to a test stand system for testing a driver assistance system with an acoustic audible sound sensor for an automotive vehicle, wherein the driver assistance system includes a control unit for processing sensor signals, which is configured to process sensor signals from environment sensors and to control the automotive vehicle on the basis thereof, wherein at least one of the environment sensors is the audible sound sensor configured to detect audible sound, and wherein the test stand system comprises:
a test stand configured in such a way that the driver assistance system, in particular can be operated on the test stand;
a simulation device configured to simulate an environment of the automotive vehicle, wherein the simulated environment comprises an acoustic audible sound environment; and
a first interface for providing the simulated environment including the acoustic audible sound environment to the driver assistance system.

The invention relates to a test stand system for testing a driver assistance system with an acoustic audible sound sensor for an automotive vehicle, wherein the driver assistance system includes a control unit for processing sensor signals which is configured to process sensor signals from environment sensors and to control the automotive vehicle based thereon, wherein at least one of the environment sensors is the audible sound sensor configured to detect audible sound.

The spread of driver assistance systems (advanced driver assistance systems-ADAS), which in a further development enable autonomous driving (AD), is constantly increasing in both the passenger car and utility vehicle sectors. Driver assistance systems make an important contribution to increasing active road safety and serve to increase driving comfort.

In addition to systems that serve in particular to ensure driving safety, such as ABS (anti-lock braking system) and ESP (electronic stability program), a large number of driver assistance systems are offered in the passenger car and utility vehicle sectors.

Driver assistance systems that are already being used to increase active road safety include a parking assistant, an adaptive cruise control (ACC), which adjusts a desired speed selected by the driver to a distance from a preceding vehicle. Another example of such driver assistance systems are ACC stop & go systems that, as an addition to ACC, cause the vehicle to continue to drive automatically in traffic jams or when vehicles are stationary, lane keeping or lane assist systems that automatically keep the vehicle in its lane, and pre-crash systems that, in the event of a possible collision, prepare or initiate braking in order to remove kinetic energy from the vehicle, and, if necessary, initiate further measures if a collision is unavoidable.

These driver assistance systems increase road safety by warning the driver in critical situations, up to initiating independent intervention to avoid or reduce accidents, for example by activating an emergency braking function. In addition, driving comfort is increased by functions such as automatic parking, automatic lane keeping and automatic distance control.

The safety and comfort gains of a driver assistance system are only perceived positively by the vehicle occupants if the support provided by the driver assistance system is safe, reliable and—as far as possible—comfortable.

In addition, each driver assistance system, depending on its function, must handle scenarios that occur in traffic with maximum safety for the host vehicle and without endangering other vehicles or other road users.

The respective degree of automation of vehicles is categorized into so-called automation levels 1 to 5 (see, for example, standard SAE J3016). The present invention relates in particular to vehicles with driver assistance systems of automation levels 3 to 5, which is generally considered to be (partially) autonomous driving.

The challenges of testing such systems are diverse. In particular, a balance must be found between the test effort and the test coverage. The main task when testing ADAS/AD functions is to demonstrate that the function of the driver assistance system is guaranteed in all conceivable situations, in particular in critical driving situations. Such critical driving situations have a certain criticality, since no or an incorrect reaction by the respective driver assistance system may lead to an accident.

For testing driver assistance systems, it is therefore required to take a large number of driving situations into account that can arise in different scenarios. The variation space of possible scenarios is generally spanned by many dimensions (e.g. different road properties, behavior of other road users, weather conditions, etc.). From this almost infinite and multidimensional parameter space, it is particularly relevant for testing driver assistance systems to extract parameter constellations for critical scenarios that may lead to unusual or dangerous driving situations.

It is known from the prior art to use real test driving data from a real fleet of test vehicles to validate and verify driver assistance systems.

Document WO 2016/110488 discloses a method for operating a driving simulator, comprising the steps of:
detecting a braking request in the driving simulator, in particular based on an actuation of a brake transmitter;
converting the detected braking request into at least one braking signal suitable for characterizing the braking request;
transmitting the at least one braking signal from the driving simulator to a test stand on which at least part of a drive train of a vehicle with at least one axle portion, in particular an axle half, and at least one brake assigned to the at least one axle portion is mounted;
rotating the at least one axle portion at a first wheel speed that corresponds to a predetermined speed of the vehicle;
actuating the at least one brake of the vehicle on the basis of the at least one braking signal;
setting a predetermined torque or a predetermined second wheel speed on the at least one axle portion by means of at least one dynamometer on the basis of properties of at least one component of the vehicle, in particular the drive train, the chassis and/or the entire vehicle, the properties being at least partially simulated;
detecting the real wheel speed at a predetermined torque or the real torque at a predetermined second wheel speed; and
outputting data of the real wheel speed or the real torque to the driving simulator.

Document DE 10 2007 031040 A1 relates to a test device for a driver assistance system that is integrated in a vehicle and has a vehicle sensor system for acquiring a signal from the environment of the vehicle, said test device comprising:
a simulator (2-6) for simulating the environment
and a simulator transmitting device connected to the simulator (2-6) for transmitting an environment simulation signal that represents the simulated environment and can be acquired by the vehicle sensor system to trigger a response of the driver assistance system.

Document EP 3 101 404 A2 relates to a test system comprising a vehicle test stand, an automotive vehicle located on the vehicle test stand, at least one signal unit provided in or on the vehicle test stand and/or in or on the automotive vehicle and/or separately from the vehicle test stand and the automotive vehicle, with which at least one vehicle operation-specific and/or optical and/or acoustic and/or haptic and/or driving situation-related and/or environment-related signal can be output or displayed and/or manipulated, at least one measuring device and a data acquisition and/or evaluation unit including an evaluation module for the data acquired by the measuring device.

It is an object of the invention to allow for a driver assistance system to be tested under conditions that are as realistic as possible. In particular, it is an object of the invention to allow for the driving operation of an automotive vehicle with such a driver assistance system to be reproduced as realistically as possible.

This object is achieved by the teaching of the independent claims. Advantageous embodiments are defined by the dependent claims.

A first aspect of the invention relates to a test stand system for testing a driver assistance system including an acoustic audible sound sensor for an automotive vehicle, wherein the driver assistance system includes a control unit for processing sensor signals, which is configured to process sensor signals from environment sensors and to control the automotive vehicle on the basis thereof, wherein at least one of the environment sensors is the audible sound sensor configured to detect audible sound, and wherein the test stand system comprises:
a test stand configured in such a way that the driver assistance system, in particular together with a drive train for the automotive vehicle, can be operated on the test stand;
a simulation device configured to simulate an environment of the automotive vehicle, wherein the simulated environment comprises an acoustic audible sound environment; and
a first interface for providing the simulated environment including the acoustic audible sound environment to the driver assistance system.

Preferably, the first interface is configured to map the simulated environment including the acoustic audible sound environment from the perspective of the respective environment sensors. Preferably, the test stand is configured as a hardware-in-the-loop test stand, as a drive train test stand or as a vehicle test stand.

A second aspect of the invention relates to a measuring assembly including a test stand on which a vehicle with a driver assistance system is arranged, wherein the driver assistance system includes a control unit for processing sensor signals, which is configured to process sensor signals from environment sensors and to control the vehicle on the basis thereof, wherein at least one of the environment sensors is an acoustic audible sound sensor configured to detect audible sound.

A third aspect of the invention relates to a measuring vehicle for generating sensor data of an environment of the measuring vehicle, wherein the environment comprises an acoustic audible sound environment, comprising:
environment sensors, wherein at least one of the environment sensors is an audible sound sensor; and
a data processing unit for processing sensor signals, which is configured to process sensor signals from the environment sensors;
a data storage configured to record sensor data, in particular with a frequency of at least 10 kHz, in particular approximately 44.1 KHz or 48 KHz:

wherein the data processing unit is further configured to synchronize the sensor data of the at least one audible sound sensor with the sensor data of the other environment sensors.

A further aspect of the invention relates to a method for testing a driver assistance system with an acoustic audible sound sensor for an automotive vehicle, wherein the driver assistance system is configured to process sensor signals from environment sensors and to control the vehicle on the basis thereof, wherein at least one of the environment sensors is the audible sound sensor configured to detect audible sound, comprising the operating steps of:
simulating an environment of the automotive vehicle, wherein the simulated environment comprises an acoustic audible sound environment;
generating a data stream mapping the simulated environment including the acoustic audible sound environment from the perspective of the respective environment sensors; and
outputting the data stream to the driver assistance system.

Further aspects of the invention relate to a computer program including instructions that, when executed by a computer, cause the computer to carry out the steps of a method according to the fourth aspect of the invention, as well as a computer-readable medium on which such a computer program is stored.

Audible sound in the context of the invention is the sound that is perceptible to humans, in particular in a spectrum of 16 Hz to 20 KHz.

An audible sound sensor in the context of the invention is preferably a microphone and is furthermore preferably suitable for stereophonic recordings.

Labeling in the sense of the invention is preferably assigning noise sources to a respective characteristic noise, said noise sources being stored as object data with respect to the sensor data.

The invention is based on the assumption that future driver assistance systems will not only take into account the visual environment of an automotive vehicle to control the automotive vehicle as well as data from the spatial environment obtained using camera, radar, lidar and ultrasonic sensors, but also information conveyed by audible sound.

Such audible sound information is usually not directly necessary for driving an automotive vehicle, but provides information about future events. For example, a siren announces that an emergency vehicle is expected to appear shortly.

Depending on the direction of origin, a screeching tire may also announce a future impairment of the road lane of the automotive vehicle.

The detection and near-real-time evaluation of acoustic environment signals will therefore probably represent an important function in reliable, highly automated vehicles in the future.

As explained in the introduction, the audible sound environment is taken into account as a further input variable when controlling the driver assistance system. This parameter, which must also be taken into account, further increases the requirements for the quantity of test kilometers to be used to test the driver assistance system.

The approach of the invention is to provide a test stand system for a driver assistance system with an audible sound sensor, which includes both a test stand configured to operate a drive train of the automotive vehicle and a simulation device configured to simulate the environment of the automotive vehicle including the acoustic audible sound environment, as well as a first interface for providing the simulated environment including the acoustic audible sound environment to the driver assistance system.

By providing the test stand on which the drive train is operated and the interface for providing the audible sound environment, a driver assistance system with audible sound sensors can be tested particularly reliably and realistically. In particular, a driving operation of the automotive vehicle can be mapped particularly realistically in this way.

In an advantageous embodiment of the test stand system, the simulation device is configured to track a movement of the vehicle in the simulated environment and to adapt the environment including the acoustic audible sound environment accordingly. By taking the movement of the vehicle into account in the simulated environment, a particularly realistic mapping of the environment can be achieved.

In a further advantageous embodiment of the test stand system, the first interface is a stimulation device configured to stimulate environment sensors and includes at least two sound transducers for audible sound, and is further configured to use the at least two sound transducers to generate a surround sound which reproduces the simulated acoustic environment on the vehicle test stand around the automotive vehicle.

Preferably, such a stimulation device is a mono loudspeaker or a plurality of stereo or surround loudspeakers.

If only one loudspeaker is present, it can only be determined whether, for example, a siren or a horn is sounding or not. If more than one loudspeaker is present, the driver assistance system can also be tested to see whether it can determine the respective direction of the sound source and, if applicable, its speed and direction of movement.

In a further advantageous embodiment, the first interface is therefore configured to map the simulated environment including the acoustic audible sound environment from the perspective of the respective environment sensors. This allows for a particularly realistic simulation of the audible sound environment to be generated on the environment sensors of the automotive vehicle.

In a further advantageous embodiment of the test stand system, the first interface is a data interface configured to provide the driver assistance system, in particular the software of the audible sound sensor, with the simulated environment as a signal, in particular as an output signal of the audible sound sensor, or data stream.

The respective interface selected depends on the components of the driver assistance system to be tested. For example, only the software of the audible sound sensor or only the driver assistance system itself may be intended to be tested while omitting the hardware and software of the audible sound sensor.

In a further advantageous embodiment, the test stand system includes a second data interface configured to provide object data or a so-called ground truth for the simulated environment.

By providing object data and/or a ground truth, an environment determined by the driver assistance system can be compared with the originally simulated environment as a reference value.

In an advantageous embodiment of the measuring vehicle, a data processing unit is further configured to determine characteristic noises from the sensor data of the at least one audible sound sensor and to recognize the acoustic source thereof and label the characteristic noises accordingly.

In this way, data recorded in real test drives can be identified in relation to an audible sound environment and the data can be prepared for use in a test stand system according to the invention.

In a further advantageous embodiment of the measuring vehicle, the data processing unit is further configured to filter the sensor data of the at least one audible sound sensor in order to remove disturbing noises, in particular wind noises, preferably up to a measuring speed of about 50 km/h.

In this way, an audible sound environment recorded by the measuring vehicle can be applied to other driving situations, regardless of the recorded driving situation.

In a further advantageous embodiment of the measuring vehicle, the data processing unit is further configured to determine a distance of an acoustic source, the direction from where the characteristic noises origin in relation to the measuring vehicle, and/or a differential speed of the acoustic source with respect to the measuring vehicle and to record them in the sensor data.

In this way, the recorded sensor data can be provided with a ground truth in relation to the directions of movement and speeds of acoustic sources.

In an advantageous embodiment of the method, the data stream is output in such a way that the audible sound sensor can generate sensor data based on the data stream, said sensor data then being output to the driver assistance system.

In this way, the driver assistance system can be tested together with the associated audible sound sensor.

In a further advantageous embodiment of the method, the data stream is output as surround sound, which reproduces the simulated acoustic environment on the automotive vehicle test stand around the automotive vehicle.

As already explained above, surround sound allows a particularly realistic reproduction of the environment.

In a further advantageous embodiment, the method comprises the steps of:
monitoring an activity of the driver assistance system; and
adapting the simulation of the environment of the automotive vehicle on the basis of a detected activity.

This in turn results in a change in the sound emission. In particular, transmission paths change. Sound sources may also change, for example a person may initially “scream” instead of “speak”. The Doppler effect may also be taken into account. The information content of the sound emission may also change, for example when a person makes an emergency call.

In a further advantageous embodiment, the method also comprises the operating step of:
degrading, in particular distorting, a data stream, in particular that part which maps the acoustic audible sound environment from the perspective of the respective environment sensors, wherein weather conditions and/or defects in the hardware of the respective environment sensor are preferably taken into account.

By degrading the data stream, data processing software of the audible sound sensor and also of the driver assistance system can be tested, in particular its ability to deal with degraded sensor data.

In a further advantageous embodiment, the method also includes the operating step of:
operating a drive train for the automotive vehicle on the basis of the simulated environment.

By operating the drive train, the reproduction of reality on the test stand can be carried out even more realistically.

The figures show at least partially schematically:

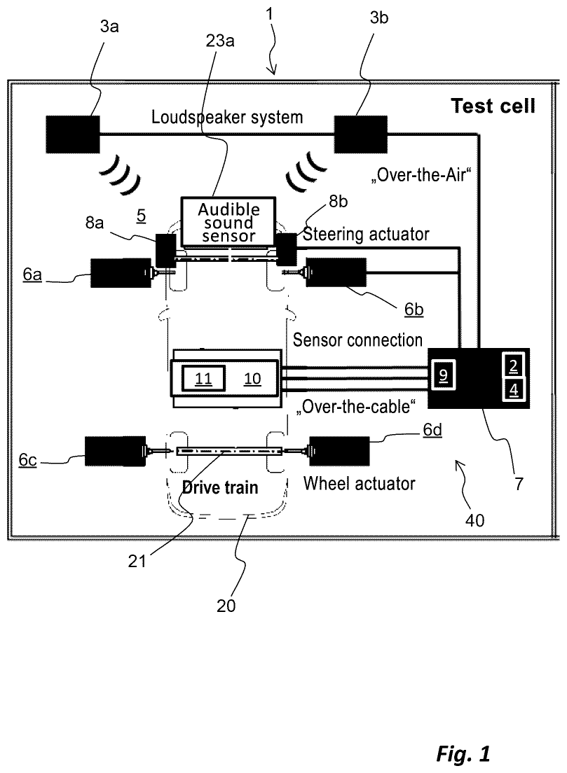

FIG. 1: an embodiment of a test stand system for testing a driver assistance system and a measuring assembly of the test stand system with an automotive vehicle;

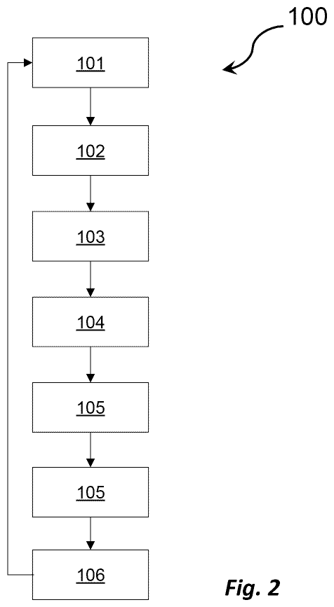

FIG. 2: an embodiment of a method for testing a driver assistance system; and

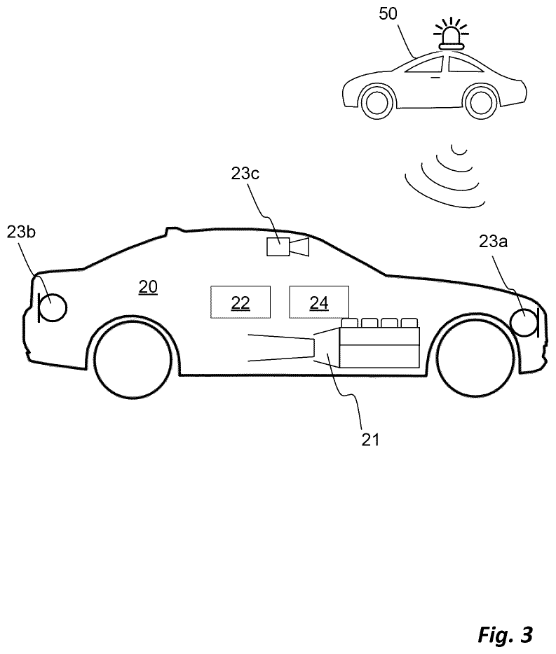

FIG. 3: an embodiment of a measuring vehicle for generating sensor data of an environment.

FIG. 1 shows a first embodiment of a test stand system 1 for testing a driver assistance system 10 with an acoustic audible sound sensor 23a for an automotive vehicle 20, wherein the test stand system 1 in the illustration is part of a measuring assembly 40, which further comprises the automotive vehicle 20.

The test stand system 1 preferably includes a data processing device 7. The data processing device 7 in turn preferably includes a simulation device 2 configured to simulate an environment of the automotive vehicle. Such a simulated environment comprises at least one acoustic audible sound environment around the automotive vehicle 20.

In order to test the driver assistance system 10, the automotive vehicle 20 is arranged on a test stand 5 and preferably fixed. The test stand 5 is preferably a drive train or vehicle test stand and includes at least two dynamometers 6c, 6d in order to simulate driving operation on a drive train 21 of the automotive vehicle 20.

Furthermore, the test stand 5 preferably includes steering actuators 8a, 8b in order to simulate steering of the vehicle 20 in a simulated driving operation. Furthermore, non-driven axles of the vehicle are preferably also operated by dynamometers 6a, 6b.

In order to allow the simulated audible sound environment of the automotive vehicle 20 to be output on the test stand 5, said test stand 5 preferably includes loudspeakers 3a, 3b configured to output audible sound. Furthermore, the test stand 5 preferably includes further interfaces in order to be able to supply or stimulate further sensors of the vehicle with data. In particular, a display configured to stimulate a camera 23c (not shown) of the driver assistance system 10 is preferably present.

The automotive vehicle 20 comprises at least the drive train 21 and a driver assistance system 10 including a control unit 11 for processing sensor signals. The automotive vehicle 20 also preferably includes environment sensors 23a, 23b, 23c configured to perceive the simulated environment around the automotive vehicle 20. In particular, the automotive vehicle 20 preferably includes a microphone 23a for detecting audible sound.

The individual devices of the test stand 5 are preferably controlled by the data processing device 7, which preferably comprises a test stand control. The data processing device 7 preferably also includes a data interface 9 configured to read out operating data of the automotive vehicle 20, in particular in relation to an activity of the driver assistance system 10.

The data processing device 7 preferably also includes a second interface 4 configured to read in object data and/or a so-called ground truth of the simulated environment. The environment sensed by the driver assistance system 10 can be compared with this ground truth. In this way, a quality of the environment detected by the driver assistance system 10, in particular an audible sound environment, may be assessed.

As an alternative to the loudspeakers 3a, 3b, the first interface may also be configured as a data interface. In this case, environment data may be provided directly to software of the audible sound sensor, in particular software for processing sensor signals.

Alternatively, a simulated transmission signal from an audible sound sensor may also be provided directly to the driver assistance system 10. Depending on which device the simulated signal is output to, corresponding components can be tested.

FIG. 2 shows an embodiment of a method for testing a driver assistance system 10 with an acoustic audible sound sensor. The method 100 is preferably carried out by a test stand system 1 according to FIG. 1.

The method 100 preferably includes the following operating steps:
In a first operating step 101, an environment of the automotive vehicle 20 is simulated, the simulated environment comprising an acoustic audible sound environment.
In a second operating step 102, the drive train 21 is operated on the basis of the simulated environment. The automotive vehicle 20 is preferably arranged on the test stand 5 for this purpose.
In a third operating step 103, a data stream is generated which maps the simulated environment including the acoustic audible sound environment from the perspective of the respective environment sensors 23a, 23b, 23c.
In a fourth operating step 104, the data stream is degraded, in particular distorted. This particularly affects the part of the data stream mapping the acoustic audible sound environment from the perspective of the respective audible sound sensors.
In a fifth operating step 105, said data stream is output to the driver assistance system 10. The data stream may be output in such a way that the audible sound sensor 23a, 23b can generate sensor data on the basis of the data stream, said sensor data then being output to the driver assistance system 10.

Alternatively, the data stream is output as surround sound reproducing the simulated acoustic environment on the vehicle test stand 1 around the automotive vehicle 20 and stimulating audible sound sensors 23a, 23b.
In a sixth operating step 106, preferably an activity of the driver assistance system 10 is monitored. Further preferably, the simulation of the environment of the automotive vehicle 20 is adapted on the basis of the detected activity of the driver assistance system 10. An activity may be characterized by an action of the driver assistance system 10, but also by the omission of an action.

Adapting the simulation of the environment results in a change in the environment of the automotive vehicle 20, in particular the audible sound environment. For example, transmission paths for emitted sound change. Sound sources change depending on how the environment reacts to an action of the driver assistance system 10, for example people on the road who give warning calls. The Doppler effect is also taken into account with respect to shifts in the frequency range due to a movement of the automotive vehicle 20 in a certain direction, preferably in the adapted simulation. The information content of the simulation also changes, for example if the driver assistance system 10 causes an accident, and further, for example, due to interactions with people.

FIG. 3 shows an embodiment of a measuring vehicle 20 for generating sensor data of an environment of the measuring vehicle 20.

The measuring vehicle 20 preferably includes a drive train 21. Furthermore, the measuring vehicle 20 preferably includes environment sensors, in particular two microphones 23a, 23b configured to sense audible sound. Preferably, one or more microphones are present which can monitor the entire environment of the vehicle in relation to audible sound. The audible sound environment in FIG. 3 is formed in particular by an excavator 50 carrying out road work and emitting sound as a sound source.

Preferably, a data processing unit 22 of the measuring vehicle 20 may determine the direction and/or the distance and/or the type of the sound source 50 and preferably its speed and direction of movement from the sensor data collected by the microphones 23a, 23b. This information is preferably stored in a data storage 24 configured to record sensor data, in particular with a frequency of at least about 10 KHz. Preferably, the data processing unit 22 is further configured to synchronize the sensor data of the at least one microphone 23a, 23b with the sensor data of other environment sensors.

Such a further environment sensor is, for example, a camera 23c recording the visual environment, in particular in the direction of travel of the vehicle 20.

Further preferably, the data processing unit 22 of the measuring vehicle 20 is configured to determine characteristic noises from the sensor data of the at least one audible sound sensor 23a, 23b, to recognize their acoustic source 50 and to label characteristic noises accordingly.

For example, sirens from emergency vehicles, horns, signals from reversing trucks and bicycle bells may be recognized based on the frequency spectra. Acoustic sources are preferably prioritized according to their general relevance for the operation of an automotive vehicle. For example, sirens from emergency vehicles and horns are given a higher priority than reversing trucks or bicycle bells.

Preferably, the data processing unit 22 is further configured to filter the sensor data of the at least one microphone 23a, 23b in order to remove disturbing noise, in particular wind noise.

It should be noted that the embodiments are merely examples that are not intended to limit the scope of protection, the application and the structure in any way. Rather, the preceding description provides the person skilled in the art with a guide for implementing at least one embodiment, wherein various changes, in particular with regard to the function and arrangement of the components described, can be made without departing from the scope of protection as apparent from the claims and combinations of features equivalent thereto.

### LIST OF REFERENCE SYMBOLS

1 test stand system
2 simulation device
3a, 3b, 3c first interface
4 second interface
5 test stand
6a, 6b, 6c, 6d dynamometer
7 data processing device
8a, 8b steering actuator
10 driver assistance system
11 control unit
20 automotive vehicle
21 drive train
22 data processing unit
23a. 23b. 23c sensors
24 data storage
40 measuring assembly
50 sound source

1-15. (canceled)

16. A system for testing a driver assistance system with an acoustic audible sound sensor for an automotive vehicle, the system including:
a test stand configured in such a way that the driver assistance system, in particular together with a drive train for the automotive vehicle, can be operated on the test stand;
a simulation device configured to simulate an environment of the automotive vehicle, the simulated environment comprising an acoustic audible sound environment; and
a first interface that provides the simulated environment including the acoustic audible sound environment to the driver assistance system, the driver assistance system including a control unit configured to process sensor signals received from the acoustic audible sound sensor and to control the automotive vehicle based at least in part on the sensor signals.

17. The system of claim 16, wherein the first interface is a stimulation device configured to stimulate environment sensors and includes at least two sound transducers for audible sound, the at least two sound transducers configured to generate a surround sound that reproduces the simulated environment on the test stand around the automotive vehicle.

18. The system of claim 16, wherein the first interface is a data interface configured to provide the driver assistance system, in particular the acoustic audible sound sensor, with a simulated environment as a signal, in particular as an output signal of the acoustic audible sound sensor, or data stream.

19. The system of claim 16, further comprising:
a measuring assembly that includes the automotive vehicle with the driver assistance system, wherein the driver assistance system includes the control unit for processing sensor signals, the control unit being configured to process sensor signals from environment sensors and to control the automotive vehicle based on the sensor signals.

20. The system of claim 16, further comprising:
a measuring vehicle for generating sensor data of an environment of the measuring vehicle, wherein the environment comprises an acoustic audible sound environment and the measuring vehicle comprises:
environment sensors, wherein at least one of the environment sensors is an audible sound sensor; and
a data processing unit for processing sensor signals, the data processing unit being configured to process sensor signals of the environment sensors;
a data storage configured to record the sensor data, in particular with a frequency of approximately 10 Hz, wherein the data processing unit is further configured to synchronize the sensor data of the acoustic audible sound sensor with the sensor data of the other environment sensors.

21. The system of claim 20, wherein the data processing unit is further configured to:
determine characteristic noises from the sensor data of the acoustic audible sound sensor;
determine an acoustic source of the characteristic noises; and
label the characteristic noises accordingly.

22. The system of claim 20, wherein the data processing unit is further configured to filter the sensor data of the acoustic audible sound sensor in order to remove disturbing noises, in particular wind noises, preferably up to a measuring speed of about 50 km/h.

23. The system of claim 21, wherein the data processing unit is further configured to determine at least one speed or distance characteristic for the acoustic source selected from a group comprising:
a distance of the acoustic source from the measuring vehicle;
a direction from which the characteristic noises originate with respect to the measuring vehicle; or
a differential speed of the acoustic source with respect to the measuring vehicle; and
wherein the data processing unit is configured to record the at least one speed or distance characteristic in the sensor data.

24. A method for testing a driver assistance system, the method comprising:
simulating an environment of an automotive vehicle, wherein the simulated environment comprises an acoustic audible sound environment;
generating a data stream that includes a mapping of the simulated environment including the acoustic audible sound environment from a perspective of acoustic audible sound sensors of the driver assistance system; and
outputting the data stream to the driver assistance system, wherein the driver assistance system is configured to process sensor signals from environmental sensors and to control the automotive vehicle on the basis thereof, the environmental sensors including acoustic audible sound sensors configured to detect audible sound.

25. The method of claim 24, wherein the data stream is output in such a way that the acoustic audible sound sensors can generate sensor data based on the data stream, the sensor data then being output to the driver assistance system.

26. The method of claim 24, wherein the data stream is output as surround sound which reproduces the acoustic audible sound environment on a test stand to stimulate the acoustic audible sound sensors, the automotive vehicle being operable on the test stand.

27. The method of claim 24, further comprising:
monitoring an activity of the driver assistance system; and
adapting the simulation of the environment of the automotive vehicle based on a detected activity.

28. The method of claim 24, further comprising:
degrading the data stream.

29. The method of claim 28, wherein the data stream is degraded based on weather conditions or defects in hardware of an environment sensor.

30. The method of claim 24, further comprising:
operating a drive train for the automotive vehicle based on the simulated environment.

31. One or more non-transitory computer-readable storage media encoding processor-executable instructions for executing a computer process, the computer process comprising:
generating acoustic audible sound within an environment of an automotive vehicle;
collecting the acoustic audible sound with one or more acoustic sound sensors;
generating a data stream that includes a mapping of the acoustic audible sound; and
providing the data stream as input to a driver assistance system configured to control the automotive vehicle based on the mapping of the acoustic audible sound.
